(19) United States
(12) Patent Application Publication
(10) Pub. No.: US 2011/0200867 A1
(43) Pub. Date: Aug. 18, 2011

(54) Modular battery with battery cell having bimetallic end plates

(75) Inventors: Duncan Culver, Howell, NJ (US); Christopher K. Dyer, Madison, NJ (US); Michael L. Epstein, Bedminster, NJ (US)

(73) Assignee: Lightening Energy, Dover, NJ (US)

(21) Appl. No.: 12/658,842

(22) Filed: Feb. 16, 2010

(51) Int. Cl. H01M 2/24; H01M 4/02

(52) U.S. Cl. 429/160; 429/209; 429/220; 29/623.1

(57) ABSTRACT

A battery cell for a modular battery includes a positive end electrode; a negative end electrode; and at least one further electrode between the positive end electrode and the negative end electrode; at least one of the positive and negative end electrodes including a first conductive layer and a second conductive layer adjacent to the first conductive layer, the first conductive layer defining an electrical contact surface facing away from the further electrode and being made of a material less susceptible to oxidation than the second conductive layer. A battery and a method are also provided.

The present invention relates to a modular battery and to a battery cell.

### BACKGROUND

Modular batteries are batteries which comprise two or more battery cells or cell modules or cells. A common example of a device using a modular battery is a hand held flashlight which may use for example two C cells.

Recently, modular batteries have become important in many applications, including hybrid electric vehicles (“HEV”), plug-in hybrid electric vehicles (“PHEV”), and other applications. When used in HEV, PHEV, and other applications, in addition to being durable, safe and cost effective, modular batteries are required to deliver a great deal of power.

Applications of modular batteries, like the hand-held flashlight, require the use of multiple battery cells connected in series. However, the modular batteries for HEVs and PHEVs, for example, may differ from the modular C cells used in a common flashlight.

U.S. Patent Publication No. 2009-0239130 A1 discloses a modular battery with battery cell modules, and is hereby incorporated by reference herein.

### SUMMARY OF THE INVENTION

The present invention provides a battery cell for a modular battery including a positive end electrode; a negative end electrode; and at least one further electrode between the positive end electrode and the negative end electrode. At least one of the positive and negative end electrodes includes a first conductive layer and a second conductive layer closer to the further electrode than the first conductive layer, the first conductive layer defining an electrical contact surface facing away from the further electrode and being made of a material less susceptible to oxidation than the second conductive layer.

The present invention also provides a modular battery having the battery cell according to the present invention and another battery cell, for example a similar battery cell, in electrical contact with the battery cell.

The present invention also provides a method for forming a modular battery by stacking a plurality of the battery cells according to the present invention.

### BRIEF DESCRIPTION OF THE DRAWINGS

The present invention will be described with respect to a preferred embodiment, in which:

FIG. 1 is a schematic cross section of the electrode arrangement within a single battery cell with interleaving electrodes and separators;

FIG. 2 is a schematic cross section of the positive end-electrode plate 14 of FIG. 1;

FIG. 3 is a schematic cross section of the negative end-electrode plate 15 of FIG. 1;

FIG. 4 is a schematic planar view of the plate of FIG. 2; and

FIG. 5 is a schematic planar view of the plate of FIG. 3.

The drawings are schematic in nature and not to scale. For clarity and ease of understanding, some elements have been exaggerated in size.

### DETAILED DESCRIPTION

U.S. Patent Publication No. 2009-0239130 A1, which is hereby incorporated by reference herein, describes cell module end plates which are made of a metal and coated on one side by an active material.

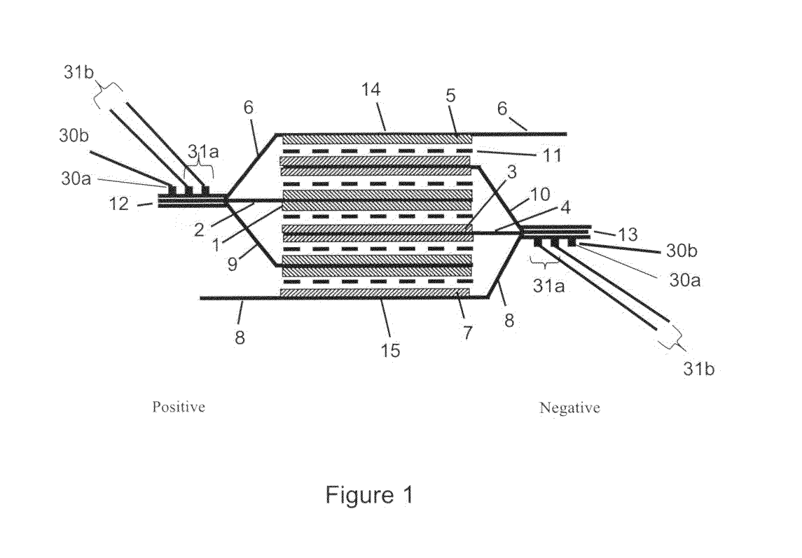

As shown in FIG. 1, the positive end-electrode plate 14 and negative end-electrode plate 15 are assembled with the positive and negative electrode plates 9, 10 within a single battery cell. In the drawings, the thickness of the active material coatings 1, 3, 5, 7 is greatly exaggerated for clarity. The positive and negative electrodes are electrically connected in parallel to multiple others of the same polarity to form an interleaved electrode assembly which is terminated by the positive end-electrode 14 and the negative end-electrode 15 of the single battery cell. The positive end-electrode plate 14 has two tabs 6 and the negative end-electrode plate 15 has two tabs 8. One of the tabs 6 of the positive end-electrode plate 14 is connected, preferably by welding, to the tabs 2 of the positive electrode plates 9 to form an end tab 12 which constitutes a positive terminal of the battery cell. In similar fashion, one of the tabs 8 of the negative end-electrode plate 15 is connected, preferably by welding, to the tabs 4 of the negative electrode plates 10 to form an end tab 13 which constitutes a negative terminal of the battery cell. Between the end-electrode plates 14, 15 are positive electrodes 9 interleaved with negative electrodes 10, and between each electrode is a layer of separator 11, with sufficient insulating properties such as a micro-porous polyolefin, containing electrolyte. The end-electrode plates 14 and 15 are shown coated on one side only while their other sides are uncoated and through the end tabs 12 and 13 respectively, their other sides present outer positive and negative cell-termination surfaces respectively for subsequent high voltage modular battery assembly through, for example interconnectors.

Unlike the end plates of U.S. Patent Publication No. 2009-0239130 A1 however, the end plates 14, 15 of FIG. 1 of the present invention are made of bimetallic foil. A low electrical resistance of the end plates for connection, for example to interconnectors, is desirable. Aluminum, for example, is susceptible to oxidation in the presence of air, and can form, disadvantageously, a hard electrically-resistive oxide film. For that reason, filling the modular battery enclosure with an inert gas can reduce formation of the oxide films. However, maintaining the inert gas can be difficult. The present invention thus provides that one side of the bimetallic foil of the end plates 14, 15 is less susceptible to oxidation and faces outwardly for further contact.

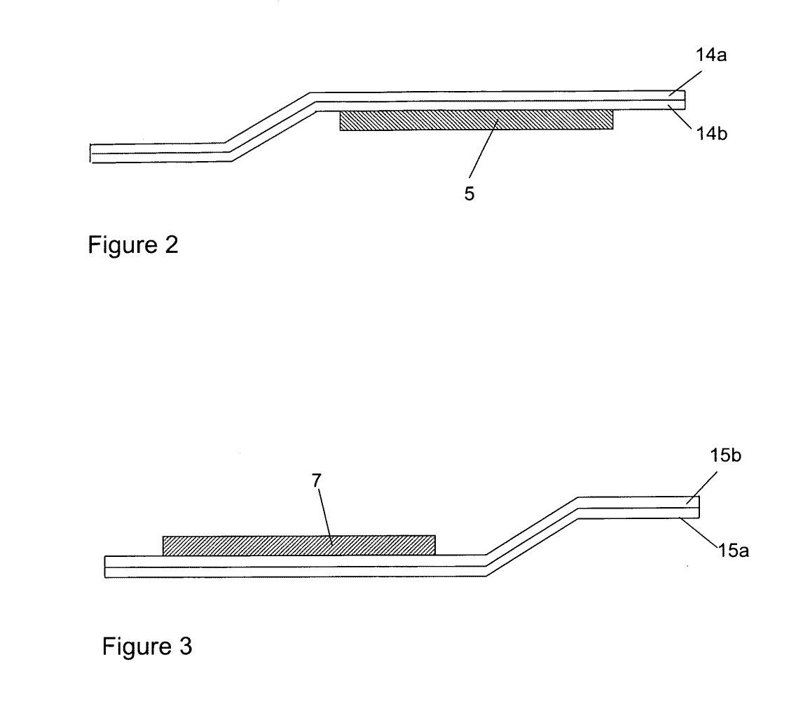

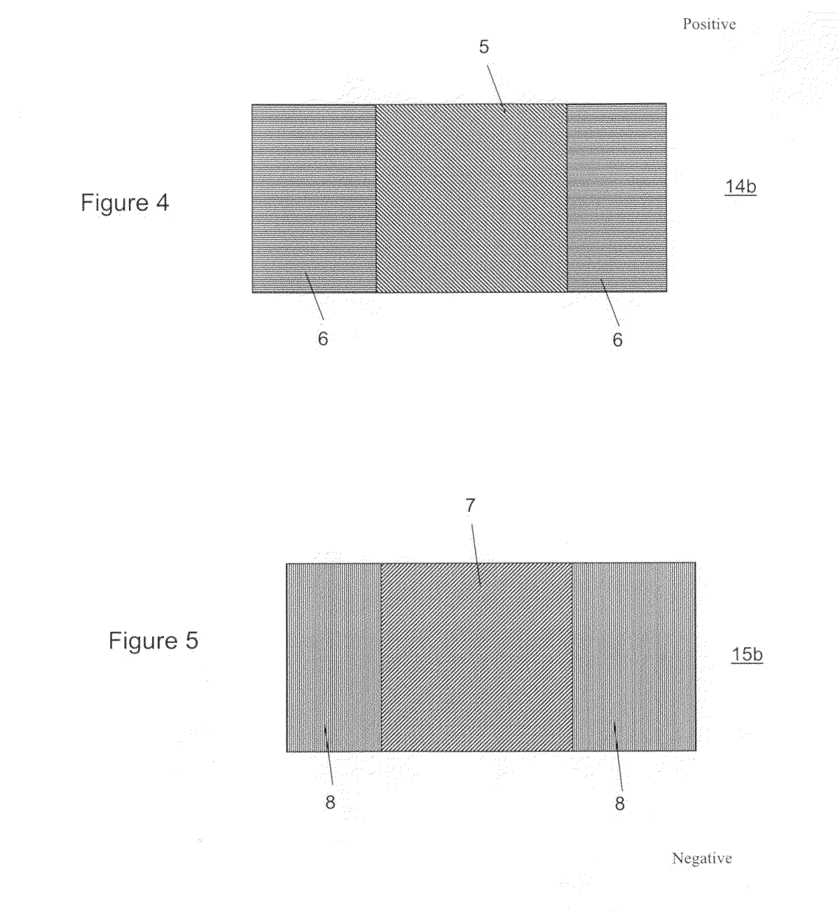

FIG. 2 shows the positive end plate 14 of the present invention, which has a bimetallic foil with a first conductive material layer 14a, for example made of copper, and a second conductive material layer 14b, for example made of aluminum. The active material coating 5 can be formed on the inwardly facing material layer 14b, as shown as well in planar view in FIG. 4. The outwardly facing material layer 14a presents a contact surface, and is made of a metal less susceptible to oxidation than the material of layer 14b. In this way, the need for inert gas in the modular battery enclosure can be reduced or eliminated. Moreover, the costs associated with bimetallic foil as opposed to, for example, a single sheet of copper can be significantly lower.

FIG. 3 shows the negative end plate 15 of the present invention, which has a bimetallic foil with a first conductive material layer 15a, for example made of copper, and a second conductive material layer 15b, for example made of aluminum. The active material coating 7 can be formed on the inwardly facing material layer 15b, as shown as well in planar view in FIG. 5. The outwardly facing material layer 15a presents a contact surface, and is made of a metal less susceptible to oxidation than the material of layer 15b.

The type of bimetallic foil used can vary, but the outwardly facing material is one less susceptible to oxidation than the inwardly facing one. The layers also need not be homogenous, so that for example, a outwardly facing layer can be defined by a mixture of aluminium/copper with a higher copper content, and the inwardly facing layer by a mixture of aluminum/copper with a higher aluminum contact. Thus a material with a gradient or implants could define two layers, as well as foil with more than two types of materials.

The battery cell of FIG. 1. then can be formed as shown in incorporated-by-reference U.S. Patent Publication No. 2009-0239130 A1, for example in FIG. 3A. Similarly made battery cells of the present invention then can be stacked to create the modular battery as shown in incorporated-by-reference U.S. Patent Publication No. 2009-0239130 A1, for example in FIG. 6A. However, the filling with inert gas can be dispensed with, if desired, so that the battery cell operates in an air environment. Moreover, other types of enclosures without the need for a tight seal can be used.

What is claimed is:

1. A battery cell for a modular battery comprising:
a positive end electrode;
a negative end electrode; and
at least one further electrode between the positive end electrode and the negative end electrode;
at least one of the positive and negative end electrodes including a first conductive layer and a second conductive layer closer to the further electrode than the first conductive layer, the first conductive layer defining an electrical contact surface facing away from the further electrode and being made of a material less susceptible to oxidation than the second conductive layer.

2. The battery cell as recited in claim 1 wherein the first conductive layer is made of copper.

3. The battery cell as recited in claim 2 wherein the second conductive layer is made of aluminum.

4. The battery cell as recited in claim 1 wherein both the positive and negative end electrodes are made of a first conductive layer and a second conductive layer.

5. The battery cell as recited in claim 1 wherein the first conductive layer and second conductive layer define a bimetallic foil.

6. The battery cell as recited in claim 1 wherein the one of the positive and negative end electrodes further includes an active material coating on the second conductive layer.

7. The battery cell as recited in claim 1 wherein the further electrode has active material coatings on both sides.

8. The battery cell as recited in claim 1 wherein the battery cell operates in an air environment.

9. The battery cell as recited in claim 1 wherein the at least one further electrode includes a plurality of further electrodes.

10. The battery cell as recited in claim 1 wherein the positive end electrode, the negative end electrode and the further electrode are electrode plates.

11. A modular battery comprising:
a first battery cell as recited in claim 1; and
a further battery cell, the first battery cell being in electrical contact with the further battery cell via the first conductive layer.

12. The modular battery as recited in claim 1.1 wherein the first battery cell is in electrical contact with the further battery cell via an interconnector.

13. A method for forming a modular battery comprising:
stacking a plurality of battery cells as recited in claim 1.

14. The method as recited in claim 13 further comprising enclosing the stacked battery cells in an air environment.
